(19) United States
(12) Patent Application Publication
(10) Pub. No.: US 2002/0068026 A1
(43) Pub. Date: Jun. 6, 2002

(54) REACTOR

(76) Inventors: LAWRENCE L. MURRELL, SOUTH PLAINFIELD, NJ (US); FRITS M. DAUTZENBERG, MAHWAH, NJ (US); RUDOLF A. OVERBEEK, CHATHAM TOWNSHIP, NJ (US); BRUCE J. TATARCHUK, AUBURN, AL (US)

Correspondence Address: ELLIOT M OLSTEIN, CARELLA BYRNE BAIN GILFILLAN CECCHI, STEWART & OLSTEIN, 6 BECKER FARM ROAD, ROSELAND, NJ, 07068

(21) Appl. No.: 09/131,152

(22) Filed: Aug. 7, 1998

Related U.S. Application Data
(60) Provisional application No. 60/055,227, filed on Aug. 8, 1997.

(51) Int. Cl. B01J 8/04; B01J 35/00

(52) U.S. Cl. 422/211; 422/218; 422/220; 422/222; 422/168

(57) ABSTRACT

A catalytic reactor and process wherein the reactor contains a fixed catalyst bed comprised of at least one layer of a mesh having catalyst particles and/or catalyst fibers retained in the interstices of the mesh, wherein the catalyst particles have an average particle size of no greater than 200 microns and the fibers have a diameter of no greater than 500 microns and wherein the wire mesh layer has a void volume of at least 45%.

This application claims the priority of U.S. Provisional Application No. 60/055,227 filed on Aug. 8, 1997.

This invention relates to a reactor and more particularly to a catalytic reactor for performing a chemical reaction. The invention further relates to a catalyst structure for use in a catalyst reactor and the use thereof.

A wide variety of catalytic reactors are known in the art. Such catalytic reactors include reactors in which the catalyst is maintained as a fixed bed (the catalyst is not entrained in the reactants) and catalytic reactors in which the catalyst is entrained in the reaction stream, such as a slurry reactor or a fluidized bed reactor. In general, catalytic reactors in which a catalyst is entrained in the reaction stream are characterized by the use of catalysts of small-particle size wherein the catalyst is maintained in a low-density in the reaction stream. Fixed bed catalytic reactors are generally characterized as having a large particle size and a relatively high catalyst loading (low-void volume).

The present invention is directed to an improved catalytic reactor and to chemical processes effected in such reactor as well as catalyst structures for such reactor.

More particularly, the present invention is directed to an apparatus and a chemical process which employs such an apparatus wherein there is provided at least one fixed catalyst bed in the reactor. The fixed bed in the reactor contains one or more layers of catalyst structure in the form of a supporting mesh which has catalyst particles or fibers retained in the interstices of the supporting mesh, with the catalyst particles having an average particle size of no greater than 200 microns. When catalyst fibers are employed, such fibers generally have a diameter of no greater than 500 microns. The fibers generally have a diameter of at least 2 nanometers and more generally at least 1 micron. The fiber diameter is generally at least 10 nanometers. The supporting mesh which contains the catalyst particles has a void volume of at least 45%. The catalyst particles may have multiple catalyst functions on each particle or fiber, or different functions can be present on separate particles or fibers. The catalyst fibers or particles are preferably porous. The mesh material that has catalyst particles or fibers retained in the interstices thereof may or may not be coated with a catalyst.

Applicant has found that by retaining catalyst particles or fibers in the interstices of a mesh, it is possible to provide a fixed catalyst bed reactor in which, contrary to prior art fixed bed reactors, the catalyst has effectively a small particle size, and is used in a low-catalyst density, i.e., there is a high-void volume. In addition, the reactor may be operated with a low pressure drop. The particles or fibers which are entrained in the supporting mesh may be a catalyst or may be a support that is impregnated with a catalyst or is coated with a thin film of catalytically active material of from 0.1 to 50 micron size where the particles or fibers that function as a support may be essentially inert.

As hereinabove noted, the average particle size of the catalyst employed in the reactor is no greater than 300 microns, and is preferably no greater than 200 microns, and in preferred embodiments is no greater than 100 microns. In general, the average particle size is at least 2 microns, more generally, at least 10 microns, and is preferably at least 20 microns and in most cases is greater than 50 microns. Average particle size may be determined, for example, by ASTM 4464-85.

As hereinabove noted, the void volume of the supporting mesh layer having catalyst particles or catalyst fibers retained in the interstices thereof is at least 45%, and is preferably at least 55%, and is more preferably at least 65%. In general, the void volume does not exceed 95%, and preferably does not exceed 90%. The term “void volume” with respect to the mesh as used herein is determined by dividing the volume of the mesh layer which is open (e.g., free of catalyst particles and material forming the mesh) by the total volume of the mesh layer (openings and mesh material and particles) and multiplying by 100. The volume percentage of the catalyst based only on catalyst and material forming the mesh may be as high as 95% and is generally at least 55%. The volume percentage of the catalyst may be higher than 95% and up to about 99%, based only on catalyst and material forming the structure.

The catalyst particles or fibers are retained in the interstices of the mesh, and as a result, the catalyst particles do not become entrained in the reactants which flow through the mesh. It is to be understood, however, that the catalyst particles may have some freedom of movement within the interstices of the mesh; however, such particles or fibers are retained in the mesh and are not entrained in the reaction stream. Thus, the particles within the mesh have some freedom of movement within the mesh but do not become entrained in the reaction stream.

In accordance with another aspect, the mesh structure may be formed from fibers which are a catalyst, with such fibers having a diameter of no greater than 30 microns, with the mesh layer having a void volume as hereinabove described. Such mesh may or may not have entrained catalyst particles or fibers retained in the interstices of the mesh.

The reactor contains at least one catalyst bed, and such catalyst bed may be formed from one or more layers of mesh having catalyst contained in the interstices thereof. In most cases, the catalyst bed is comprised of multi-layers of such mesh having catalyst retained in the interstices thereof.

The mesh having catalyst particles or fibers retained in the interstices thereof, in accordance with the present invention, may be formed into a wide variety of shapes and, therefore, may be employed as a packing element for a catalytic reactor. Thus, for example, the mesh may be fabricated into corrugated packing elements, wherein each corrugated packing element which forms the fixed catalyst bed is formed of a mesh having catalysts retained in the interstices thereof, which catalyst has a particle or fiber size as hereinabove noted and wherein the void volume of the corrugated mesh is as hereinabove described. The catalyst bed can be formed from a plurality of such corrugated elements, and the elements may be arranged in a wide variety of shapes and forms.

Thus, for example, U.S. Pat. No. 4,731,229 discloses a reactor having corrugated packing elements. Corrugated packing elements of this type may be fabricated from mesh having catalyst particles retained in the interstices thereof, in which case the catalyst “tape” disclosed in such patent is not required.

The mesh may also be formed into shapes such as disclosed in U.S. Pat. No. 4,731,229; No. 5,189,001; No. 5,431,890; No. 5,032,156; European 0-396-650-B1; European 0-367-717-B1; European 0-433-222-B1. These and other shapes should be apparent to those skilled in the art from the teachings herein.

Thus, in accordance with an aspect of the present invention, there is provided a catalytic reactor which includes packing elements in the form of a mesh, with the mesh having catalyst particles or fibers retained in the interstices thereof, with the catalyst particles having an average particle size of no greater than 200 microns, and wherein the mesh layer which is used in forming the packing element has a void volume of at least 45%. The particles or fibers may be comprised of one, two or more catalytic materials and may be comprised of only catalyst or may be comprised of a support comprised of particles or fibers that are impregnated or coated with a catalyst.

Thus, in accordance with an aspect of the present invention, there is provided a three-dimensional catalyst support, or packing, for a catalytic reactor, wherein the support, or packing, is formed of a mesh and having catalyst in particulate form or as fibers retained in the interstices of the wire mesh, which has the characteristics hereinabove described.

The mesh is preferably formed of a metal, however, other materials may be employed, such as a ceramic. As representative examples of such metals, there may be mentioned: nickel, various stainless steels; e.g., 304, 310 and 316, hastalloy, Fe—Cr alloys, etc.

The mesh may be formed from fibers, with such fibers generally having a diameter of at least 1 micron with the fibers having a diameter which generally does not exceed 25 microns, although smaller or larger diameters may be used.

It is to be understood that the mesh support may be comprised of one type of fiber or may be comprised of two or more different fibers and the mesh fibers may have a single diameter or may have different diameters. Additionally, the fibers can be coated with a thin film of catalyst whereby the mesh support is coated with catalyst in addition to having catalyst fibers or particles retained in interstices of the mesh support.

The mesh containing catalyst particles or fibers may be initially formed by producing a mesh having a catalyst support retained in the interstices thereof, followed by impregnating the retained support with an appropriate catalyst. Alternatively, the mesh may be produced with supported or unsupported catalyst particles in the mesh. As a further alternative, the mesh may be produced wherein the particles retained therein are catalyst precursors, which precursors are subsequently converted to an active catalyst. As a further example, the mesh may be initially formed and the catalyst or catalyst precursors inserted into the interstices of the mesh after formation of the mesh.

Thus, in accordance with an aspect of the present invention, the mesh may be initially provided with particles or fibers retained in the interstices thereof, wherein such particles or fibers may be a catalyst, or may be a catalyst support without catalyst, or may be a catalyst support with catalyst, or may be a catalyst precursor. In the case where the particles or fibers do not contain active catalyst, the particles or fibers retained in the mesh may be subsequently provided with an active catalyst. In the case, where the particles or fibers are a catalyst precursor, the precursor may be converted to active catalysts by procedures known in the art.

The mesh having particles or fibers retained in the interstices thereof is preferably produced by a procedure of the type described in U.S. Pat. Nos. 5,304,330; 5,080,962; 5,102,745; or 5,096,663, wherein a composite is formed from metal fibers, cellulose fibers and the particles or fibers to be retained within the wire mesh and water, which is then cast into the desired form, followed by removal of substantially all of the cellulose fibers by gasifying thereof at an elevated temperature, preferably in a reducing atmosphere, which elevated temperature also sinters the metal fibers to produce a mesh. In some cases, it may be desirable to leave incompletely gasified or non-reacted cellulose fibers within the network to serve as a support or as a catalytic material. The Examples describe a representative procedure for producing a mesh having retained catalyst particles in accordance with the present invention; however, it is to be understood that, although such a procedure is preferred, it is possible within the scope of the present invention to produce such a mesh by other procedures. Other procedures may be employed for removing cellulose including the removal of cellulose prior to sintering and in the absence of hydrogen. In such a case, a catalyst may be used to lower the temperature at which the cellulose is removed.

In producing the mesh, as hereinabove described, a desired void volume is obtained by selecting the relative amounts of cellulose, metal and particles or fibers used in the mixture, as well as the diameter of the metal fibers and the size of the particles or fibers. The mesh structure is thus comprised of a plurality of layers of fibers that are randomly oriented in such layers. In general, the mesh comprised of the fibers has a thickness of at least 5 microns and generally does not exceed 10 mm. In a preferred embodiment, the thickness of the mesh is at least 50 microns and, more generally, at least 100 microns. In many cases, the thickness does not exceed 2 mm.

The mesh structures can be formed into three dimensional structures in a large number of ways. The formed composite containing the cellulose fibers and the metal, e.g., nickel metal, which may contain the catalyst support or catalyst particles or fibers themselves, e.g., zeolites or mixtures of components, can be formed onto a backing structure which provide the structural stability of the system. The composite formed on the backing material can then be treated in a reducing gas atmosphere to remove the cellulose fibers while simultaneously bonding the metal fibers to each other, and to the structural backing material. This is preferably done where the backed materials are treated as stacked sheets in the furnace under inert or reducing conditions which then can be formed into a variety of three-dimensional structures. This forming process can be accomplished by passing the formed sheets through a crimping device to make a channel structure resembling the channel structure in monolith structures. It is preferable to have the structures formed where the sheet is passed through a crimping device which imposes a small alternating pattern to the sheet before it is formed in a larger structure in a second crimping device which forms the main channels of the formed structure. In this way the channel walls of the structure will have a periodic secondary structure to aid in forming turbulent flow through the structure by breaking up the boundary layer at the surface of the channel. In addition, by altering the periodicity of the initially imposed primary structure and the size of the imposed structures, gas-liquid, gas-gas and liquid-liquid mixing can be maximized for a given channel dimension which is also designed for a given application's requirements. There are also a very large number of structures that can be formed from the flat sheets where the composite is bonded to the backing sheet by folding the sheet in periodic fashion to form a triangular or hexagonal channel in one dimension which can be stacked in a variety of ways to form a structure to enhance mixing characteristics for various applications, including catalytic distillation. It is possible to envision attachment of the layered structures by mechanical means such a staples, or as tabs formed by the structure itself which allows the sheets to interlock to form a stable three-dimensional structure. This may be achieved by interlocking the sheets through slots or holes punched in alternating sheets which allows the tabs in the alternating sheets to penetrate and to be affixed by locking the tabs by various mechanical means, including bending or twisting of the tabs. It is possible to form such three-dimensional structures before the treatment process which removes the cellulose fibers, and then to pass these formed structures through the furnace where the treatment will serve to attach the structure at the contact points in the formed body. It may be desirable to form the three-dimensional structures before the treatment process which removes the cellulose fibers, and then to pass these formed structures through the furnace where the treatment will serve to attach the structure at the contact points in the formed body. It may be desirable to form the three-dimensional structures that have openings in the sheets, such as circles of one or more sizes, formed prior to the furnace treatment so that when the sheets are formed into three dimensional structures the desired hydrodynamic flow and mixing can be achieved in the structure. This can be envisioned more clearly in the case of the walls of the formed monolith where openings, such as circular holes, will readily allow the gas and/or liquid flow to traverse the channels of the formed structure leading to facile cross channel flow. An alternative approach to attach the folded sheets, or channel contacts in a monolith structure is to form welds at the contact points within the structure. There are many approaches to carry out precision welding within such structures, including welding in laser welding devices.

Another approach to make composite structures which can be formed into sheets which can be subsequently converted into three dimensional structures is to make sheets as layered structures which contain microfibers of larger dimension so that the sheets will have the required structural stability in the subsequent forming steps. For example, it is possible to form a layer with 12 micron-size metal fibers which has a second layer of 2 micron-size metal fibers which may, preferably, contain the catalyst support or catalyst particles in this layer. Alternatively, a composite containing mixtures of two, or more, sizes of metal fibers in the composite can be used to form a single composite structure with the necessary mechanical stability so that, for example, a backing is not necessary in the final formed structure. This will allow certain advantages in the effective utilization of a given reactor volume to maximize the catalyst concentration within that volume by elimination of the volume occupied by the backing material from the structure. The ideal structure for a given application will depend on the volumetric activity required combined with the value added to the process by the structured catalysts of this invention. In some applications the cost of the catalyst may be the deciding factor in the choice of the method of preparation, while in others the main factor is the performance and selectivity advantages provided by one method of preparation or another. The maximum size of the desired structures for a given application is also an important consideration. There is a great ease in forming monolith structures with the sheets formed from the structures up to a size of about 12 in diameter cylinders by 6 inch length. Beyond this size, there is an advantage for forming the structures from corrugated sheets which are assembled into structures which provide the desired degree of mixing characteristics combined with effective heat and mass transfer essential for a given application. A feature of the catalysts of this invention will be the improved activity and selectivity realized by having the catalyst concentration controlled in the three dimensional space in a desired concentration within a highly porous supporting structure provided by the mesh scaffolding. Particular advantages to be realized by these novel catalyst structures is with respect to reactions that are very fast, such as hydrogenation and oxidation processes where the reaction is limited by the amount of geometric surface area within the reactor volume. The small particles of catalyst within these structures will have a controllable geometric surface area which may be tailored both radically and axially in a typical fixed bed reactor configuration for a given application. This may be envisioned to be, in one possible case, the equivalent of the catalyst concentration that is present in a fluid bed of small catalyst particles. The mesh scaffolding allows the very small catalyst particles to be suspended in space which will be equivalent to a “frozen” fluid bed. The catalyst particles will not be carried from the fixed bed unit but will remain in their fixed positions so that it will be very easy to remove the reaction products from the catalyst while maintaining the high volumetric productivity. The difficulty in achieving high catalyst utilization (i.e, high effectiveness factor) for moderate to fast reactions is well known to those skilled in the art. This invention provides a means to increase catalyst utilization (increase the effectiveness factor) by utilizing small catalyst particles that may be comprised of small particles that have a thin catalyst coating while eliminating the disadvantages of conventional reactor systems (such as slurry reactors or fluid bed reactors) used for this purpose. In this respect, the present invention can provide for a volumetric performance which would match that presently only achievable with small particles employed in a slurry reactor process. Such liquid slurry processes or a gas fluidized process have serious problems with catalyst separation issues which are not an issue for this invention wherein catalyst is entrapped within a porous mesh structure configured to function as a fixed bed reactor.

The catalytic reactor may be employed for a wide variety of chemical reactions. As representative examples of such chemical reactions, there may be mentioned hydrogenation reactions, oxidations, dehydrogenation reactions, alkylation reactions, hydrotreating, condensation reactions, hydrocracking, etherification reactions, isomerization reactions, selective catalytic reductions, and catalytic removal of volatile organic compounds.

The catalyst employed in the present invention may be any one of a wide variety of catalysts. As representative examples of such catalysts, there may be mentioned: zeolites, group VIII metals, nickel, etc. As suitable supports, there may be mentioned, alumina, silica, silica-alumina, etc.

The catalytic reactor is operated at conditions which are suitable for the specific type of reaction which is being performed in the reactor.

The present invention will be described with respect to the following examples; however, the scope of the invention is not to be limited thereby:

### EXAMPLE 1

Materials:

The mesh forming material was nickel fibers (Memtec) with 2 μm, 4 μm, 8 μm, and 12 μm diameters which were used as received. The catalyst and/or support for a catalyst was one of the following:o Silica gel (Davidson), gamma-alumina (Condea and Harshaw), alpha-alumina (Cabot), silica-alumina (Davison), Beta-zeolite (PQ Corporation), magnesia (Harshaw) and carbon black (Cabot) powders which was used as received. The mean particle size of the powders was typically 55 μm.

Preform Fabrication

The paper preforms were prepared according to TAPPI Standard 205 using Noram equipment. The metal fibers, cellulose fibers and ceramic particles (or fibers) were combined simultaneously and mixed at 50 Hz for 5 minutes in approximately 1 liter of water. This dispersed mixture was collected on a 200 cm circular sheet mold as a wet composite preform. The wet preforms were dried overnight in air at 60 C.

Sintering of Composite Preforms

The dried preforms were cut into 12 cm rectangular (2 cm×6 cm) pieces and assembled into stacks composed of one to ten individual pieces. The stacked preforms were placed between two quartz plates (also 2 cm×6 cm). Normally, the preforms were separated from the quartz plates with a thin layers of alumina-silica cloth to prevent sintering of the preforms to the quartz plates. This assembly was held in place by a single quartz clip. Alternatively, the stacked preforms were placed between two pieces of heat resistant stainless steel screen (DIN 1.4767, also 2 cm×6 cm), with no separating layers of alumina-silica cloth, and held in place by a single quartz clip. The sample was placed in a quartz U-tube reactor (25 mm diameter×300 mm length) heated by a vertical sintering furnace (Heviduty). The sintering was performed in a reducing environment of H₂ with a flow rate of 50-100 cm/min (STP) at a total pressure of 1 atmosphere. Oxidation to remove residual cellulose, if necessary, was performed in air at a flow rate of 50 cm/min (STP) at a total pressure of 1 atmosphere. Rereduction was performed in a reducing H₂environment with a flow rate of 50 cm/min at a total pressure of 1 atmosphere. Before sintering and between reductions and oxidations, the reactor was purged with feed gas for 15 minutes prior to introduction to the furnace. Sintering was performed for 30 minutes at temperatures between 1123K and 1273K, oxidation was performed at 873K for 15 minutes and rereduction was performed for 15 minutes at 15 minutes at either 1123K or the sintering temperature, whichever was lower. H₂ (purity 99.97%) and air were supplied by Airco.

### EXAMPLE 2

A composite preform was constructed of 2 μm nickel fibers, cellulose fibers, and Davison silica gel (mean dp=55 μm). The composite was prepared as a 200 cm circular preform according to the procedure mentioned above utilizing 1.0 g of 2 μm nickel fibers, 1.0 g of cellulose fibers, and 1.0 g of Davison silica gel microspheres. These components were agitated at 50 Hz for 5 minutes in 1 liter of water and prepared as a wet preform by settling onto a filtration screen. After drying, the preform was cut into pieces, stacked, and sintered at 1273K for 30 minutes in the presence of H₂. The preform was subsequently oxidized in air at 873K for 15 minutes and rereduced at 1273K for 15 minutes in H₂.

Palladium catalyst was added to two of the above-formed structures to form two structures as follows:

Tetraaminepalladium (II) chloride monohydrate from Aldrich, 99.99%, was dissolved in distilled water and this solution was added to the Ni fiber using an eye dropper. This was then dried at 115 C for 1 hour and calcined at 400 C for 2 hours. Pd dispersion was measured by using CO pulse chemisorption in the Altamira instrument.

| | Sample | | | | Pd in | Pd |
|---|---|---|---|---|---|---|
| | Weight | Pd Salt | H2O | Pd | Sample | Dispersion |
| # | g | g | cc | g | % | % |
| 1 | 1.71 | 0.0248 | 10 | 0.0100 | 0.585 | 5.3 |
| 2 | 0.48 | 0.0011 | 3 | 0.00044 | 0.092 | 32.5 |

The present invention provides for an improved reactor and improved chemical reaction in that by employing a fixed bed in accordance with the present invention, one or more of the following improvements can be obtained: low by-product formation (improved selectivity); higher volumetric activity per unit of reactor volume; enhanced catalyst life; minimization or elimination of back-mixing; lower pressure drop; improved mixing of reactants and/or products as liquids and/or gases; higher geometric surface area to volume ratio of the catalyst; improved mass and heat transfer, etc.

Numerous modifications and variations of the present inventions are possible in light of the above teachings and, therefore, within the scope of the appended claims, the invention may be practiced otherwise than as particularly described.

1. An apparatus, comprising:
a reactor, at least one fixed catalyst bed in said reactor, said bed comprising at least one layer of a mesh, said mesh having retained in the interstices of the mesh, a catalyst comprising at least one member selected from the group consisting of particles having an average particle size of no greater than 200 microns and, having a diameter of no greater than 500 microns, said layer of mesh containing said catalyst in the interstices thereof having a void volume of at least 45%.

2. The apparatus of claim 1 wherein said mesh comprises a plurality of layers of metal fibers.

3. The apparatus of claim 2 wherein the void volume is at least 65%.

4. The apparatus of claim 3 wherein said member is particles.

5. The apparatus of claim 4 wherein said particles comprise a catalytic material supported on a particulate support.

6. The apparatus of claim 2 wherein said fibers forming the mesh have a diameter of at least 1 micron and no greater than 25 microns.

7. The apparatus of claim 1 wherein said reactor contains a plurality of layers of said mesh, said mesh being in the form of a packing element.

8. The apparatus of claim 7 wherein said packing element is corrugated.

9. The reactor of claim 4 wherein the particles have an average particle size of at least 10 microns.

10. The reactor of claim 1 wherein said catalyst retained in the interstices of the mesh comprises a particulate catalyst support and a catalytically active material on said support, said void volume is at least 65%, and said mesh comprises metal fibers.

11. The reactor of claim 10 wherein the mesh has a thickness of at least 50 microns.

12. The reactor of claim 10 wherein the mesh comprises metal fibers.

13. A process, comprising:
effecting a chemical reaction in the reactor of claim 1.

14. A catalyst structure, comprising:
at least one layer of a mesh, said mesh having retained in the interstices of the mesh, a catalyst comprising at least one member selected from the group consisting of particles having an average particle size of no greater than 200 microns and fibers having a diameter of no greater than 500 microns, said layer of mesh containing said catalyst in the interstices thereof having a void volume of at least 45%.

15. The structure of claim 14 where the void volume is at least 65%.

16. The apparatus of claim 15 wherein said fibers forming the mesh have a diameter of at least 1 micron and no greater than 25 microns.

17. The reactor of claim 14 wherein said catalyst retained in the interstices of the mesh comprises a particulate catalyst support and a catalytically active material on said support, said void volume is at least 65%, and said mesh comprises metal fibers.

18. The reactor of claim 17 wherein the mesh has a thickness of at least 50 microns.

19. The reactor of claim 18 wherein the mesh comprises metal fibers.

20. The reactor of claim 7 wherein the packing element indicates attached layers of said mesh.
